(19) United States
(12) Patent Application Publication
(10) Pub. No.: US 2019/0286365 A1
(43) Pub. Date: Sep. 19, 2019

(54) FLASH MEMORY CONTROLLER AND METHOD FOR CONTROLLING FLASH MEMORY

(71) Applicant: Q-SILICON TECHNOLOGIES CORP., TAIPEI CITY (TW)

(72) Inventors: FU-SHENG CHUANG, TAIPEI CITY (TW); MING-TING HSIEH, TAIPEI CITY (TW); CHENG-CHUNG YEH, TAIPEI CITY (TW)

(21) Appl. No.: 15/920,926

(22) Filed: Mar. 14, 2018

(51) Int. Cl. G06F 3/06

(52) U.S. Cl. CPC G06F 3/0659; G06F 3/0679; G06F 3/0604

(57) ABSTRACT

The present invention discloses a flash memory controller and a control method thereof. The flash memory controller comprises a scrambling circuit and a control circuit. The scrambling circuit scrambles at least one input data for generating at least one valid data. The control circuit receives at least one invalid data and the valid data generated by the scrambling circuit. The invalid data is not a fixed constant. The control circuit writes the valid data to at least one valid storage zone of a flash memory and the invalid data to at least one invalid storage zone of the flash memory. By writing non-fixed-constant invalid data to the invalid storage zones of the flash memory, the interference of the invalid storage zones on the valid storage zones may be decreased. Thereby, the reliability and the usable storage space of the flash memory may be increased.

### FIELD OF THE INVENTION

The present invention relates generally to a flash memory, and particularly to a flash memory controller and a method for controlling the flash memory.

### BACKGROUND OF THE INVENTION

Due to the prosperous development of electronic products, consumers' demand in storage media is driven to increase. Thanks to their properties of rewritability, fast access time, non-volatility, low power consumption, and small size, rewritable non-volatile memories, flash memories, in particular, are most suitable for the storage media in electronic products.

In general, some storage zones of certain flash memories have damaged at shipment. Although data still can be written to the damaged storage zones, the read data from the damaged storage zones are different from the original data, indicating that data cannot be stored in the damaged storage zones normally. Thereby, while writing data to flash memories, data should be written to undamaged storage zones instead of damaged ones. According to the current technology, while writing data to the undamaged storage zones of flash memories, fixed constants will be written to the damaged storage zones as well, meaning that identical values are written to the damaged zones. These fixed constants are invalid data, while the data written to the undamaged zones are valid data.

Writing data to the flash memory is accomplished by changing the storage states of the storage elements in the flash memory by using voltages. The voltages are generated by charging using a charging circuit. Once the data to be written are different, the voltages generated by the charging circuit will be different. According to the current technology, while writing a constant to a damaged zone via charging using the charging circuit, the charging process of the charging circuit will interfere the storage elements in the undamaged storage zones near the damaged zone owing to the coupling effect. This interference might influence the storage states of the storage elements in the undamaged zones, meaning that errors might occur to the valid data stored in the undamaged zones and deteriorating the reliability of the flash memory. In other words, during the charging period of writing fixed constants to a plurality of damaged storage zones for multiple times, if larger coupling interference due to the charging process for writing these fixed constants in the storage elements in the nearby undamaged zones occurs, voltage shifts of the storage voltages in the nearby undamaged storage zones happen easily. Consequently, the data stored in the undamaged storage zones may become error data different from the original ones.

In addition, if an undamaged storage zone is located between two damaged storage zones, because the two damaged storage zones have been written fixed constants (invalid data), the storage elements in the undamaged storage zone between the two will be influenced during the charging process of the charging circuit for the two damaged storage zones and thus increasing the error rate of the valid data stored in the undamaged storage zone. In this case, the undamaged storage zone will be listed as a damaged storage zone and hence decrease the usable storage space of the flash memory.

Furthermore, in some requirements, such as the requirement for managing the flash memory conveniently, the flash memory will include some unused storage zones storing no valid data. According to the current technology, when valid data are written to the flash memory, the valid data will not be written to the unused storage zones. Instead, the system will write the invalid data, which are fixed constants, to the unused storage zones by default. In general, unused storage zones are adjacent to usable ones. When the usable storage zones nearby the unused storage zones are not damaged, valid data will be written to the usable storage zones. Unfortunately, while writing fixed constants (invalid data) to the unused storage zones by charging using the charging circuit, the charging process of the charging circuit will interfere the storage elements in the nearby usable storage zones. This interference might influence the storage states of the storage elements in the usable storage zones. It means that the valid data stored in the usable storage zones might have errors. Then the reliability of the flash memory is lowered.

Accordingly, the present invention discloses a flash memory controller and a method for controlling the flash memory for reducing the interference of damaged storage zones and unused storage zones in undamaged storage zones. Thereby, the reliability and usable storage space of the flash memory may be increased.

### SUMMARY

An objective of the present invention is to provide a flash memory controller and a method for controlling a flash memory, which may write non-fixed-constant invalid data to damaged storage zones for reducing the interference of damaged storage zones in undamaged storage zones. Thereby, the reliability and usable storage space of the flash memory may be increased.

Another objective of the present invention is to provide a flash memory controller and a method for controlling a flash memory, which may write non-fixed-constant invalid data to unused storage zones for reducing the interference of unused storage zones in undamaged storage zones. Thereby, the reliability of the flash memory may be increased.

The present invention discloses a flash memory controller, which comprises a scrambling circuit and a control circuit. The scrambling circuit receives and scrambles at least one input data for generating at least one valid data. The control circuit receives at least one invalid data and the valid data generated by the scrambling circuit. The invalid data are not a fixed constant. The control circuit writes the valid data to at least one valid storage zone of the flash memory and the invalid data to at least one invalid storage zone of the flash memory.

The present invention discloses a method for controlling a flash memory, which comprises steps of receiving at least one input data, scrambling the input data for generating at least one valid data, providing at least one invalid data and the invalid data being not a fixed constant, writing the valid data to at least one valid storage zone of the flash memory, and writing the invalid data to at least one invalid storage zone of the flash memory.

### BRIEF DESCRIPTION OF THE DRAWINGS

The accompanying drawings are included to provide further understanding of the invention, and are incorporated into and constitute a part of this specification. The drawings illustrate embodiments of the invention and, together with the description, serve to explain the principles of the invention.

FIG. 1 shows a block diagram of the flash memory controller according to an embodiment of the present invention;

FIG. 2 shows a schematic diagram of the flash memory according to an embodiment of the present invention;

FIG. 3 shows a schematic diagram of a storage page of the flash memory according to an embodiment of the present invention;

FIG. 4A shows a schematic diagram of a storage page of the flash memory without written data according to an embodiment of the present invention;

FIG. 4B shows a schematic diagram of the storage page in FIG. 4A with written data;

FIG. 5A shows a schematic diagram of a storage page of the flash memory without written data according to another embodiment of the present invention; and

FIG. 5B shows a schematic diagram of the storage page in FIG. 5A with written data.

### DETAILED DESCRIPTION

In the specifications and subsequent claims, certain words are used for representing specific elements. A person having ordinary skill in the art should know that hardware manufacturers might use different nouns to call the same element. In the specifications and subsequent claims, the differences in names are not used for distinguishing elements. Instead, the differences in functions are the guidelines for distinguishing. In the whole specifications and subsequent claims, the word “comprising” is an open language and should be explained as “comprising but not limited to”. Besides, the word “couple” includes any direct and indirect electrical connection. Thereby, if the description is that a first device is coupled to a second device, it means that the first device is connected electrically to the second device directly, or the first device is connected electrically to the second device via other device or connecting means indirectly.

In order to make the architecture and characteristics as well as the effectiveness of the present invention to be further understood and recognized, the detailed description of the present invention is provided as follows along with embodiments and accompanying figures.

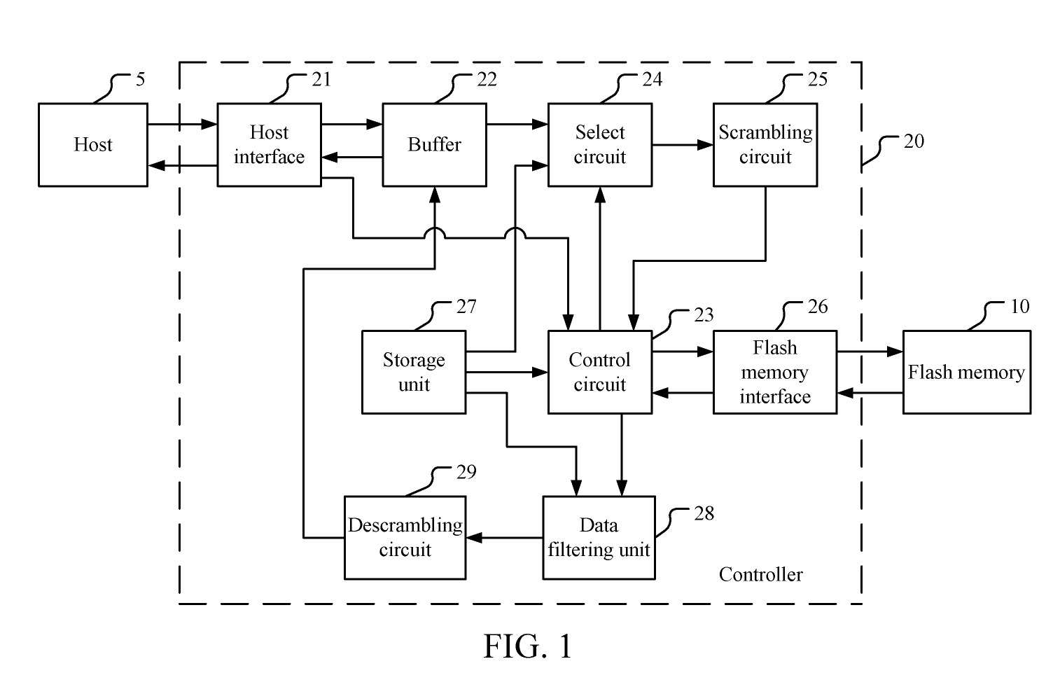

Please refer to FIG. 1, which shows a block diagram of the flash memory controller according to an embodiment of the present invention. As shown in the figure, the present invention discloses a controller 20, which is coupled to a flash memory 10 for controlling the flash memory 10. The controller 20 is further coupled to a host 5. The controller 20 may receive the data transmitted by the host 5 and write data to the flash memory 10 for storing the data transmitted by the host 5 to the flash memory 10. Alternatively, the controller 20 may read data from the flash memory 10 and transmit the read data to the host 5. The host 5 described above may work with the controller 20 for storing data to any electronic devices containing the flash memory, such as computer systems, mobile phones, digital cameras, audio players, or video players. The data transmitted from the above host 5 to the controller 20 and to be stored into the flash memory 10 are input data.

When at least one input data is to be stored into the flash memory 10, the controller 20 scrambles the at least one input data for generating at least one valid data, and writes the at least one valid data to at least one usable undamaged storage zone of the flash memory 10, and writes at least one invalid data to at least one damaged storage zone and at least one unused storage zone of the flash memory 10, respectively. The invalid input data are not a fixed constant, meaning that the invalid data written to each of the damaged storage zones and each of the unused storage zones are different. Because valid data are written to the usable undamaged storage zones instead of the damaged storage zones and unused storage zones, the usable undamaged storage zones are valid storage zones and the damaged storage zones and the unused storage zones are invalid storage zones. During the process when the controller 20 writes the valid data to the valid storage zones, the controller 20 also writes the non-fixed-constant invalid data to the invalid storage zones. Thereby, the coupling interference, including the capacitive coupling effect or the signal transmission interference, of the invalid storage zones in the nearby valid storage zones may be reduced. Consequently, the reliability and the usable storage space of the flash memory 10 may be increased. In the following, the architecture and the operation of the controller 20 will be described in detail.

As shown in FIG. 1, the controller 20 according to the present invention comprises a host interface 21, a buffer 22, a control circuit 23, a select circuit 24, a scrambling circuit 25, and a flash memory interface 26. The host interface 21 is coupled to the host 5. The host 5 transmits the input data and commands to the host interface 21. The above host 5 transmits the input data to the controller 20 via the host interface 21 with the purpose of storing the input data to the flash memory 10 via the controller 20. The host interface 21 is further coupled to the buffer 22 and the control circuit 23. The host interface 21 transmits commands to the control circuit 23. According to the present embodiment, the commands may be write commands or read commands. According to the commands, the control circuit 23 knows the host 5 is going to write the input data to the flash memory 10 or to read data from the flash memory 10.

In addition, the host interface 21 transmits the input data to the buffer 22, which is used for buffering the input data. The buffer 22 is further coupled to the select circuit 24 and transmits the input data to the select circuit 24. According to the above description, the host interface 21 transmits the commands of the host 5 to the control circuit 23 and provides the input data transmitted by the host 5 to the select circuit 24. Besides, the select circuit 24 further receives a reference data. The select circuit 24 is further coupled to the control circuit 23. The control circuit 23 controls the select circuit 24 to select the reference data or the input data transmitted by the host 5 for outputting the reference data or the input data. According to an embodiment of the present invention, the select circuit 24 may be a multiplexer and the reference data may be a fixed-constant data. For example, the reference data may be FF or AA (hexadecimal). Then it means that each byte of the reference data is a constant data of F or A. In other words, the fixed constant according to the embodiment means that the values of the bytes in each data are identical.

Please refer again to FIG. 1. The scrambling circuit 25 is coupled to the select circuit 24, receives the input data and reference data output by the select circuit 24, scrambles the input data to generate the valid data, and scrambles the reference data to generate the invalid data. After scrambling, the reference data becomes non-fixed-constant invalid data. For example, the non-fixed constant may be F1 or A2. Likewise, after scrambling by the scrambling circuit 25, each input data become a valid data having different values (non-fixed constant) for reducing the coupling interference in the charging period when each valid data is being written to the flash memory 10.

According to an embodiment of the present invention, the scrambling circuit 25 includes at least one preset scrambling parameter. The scrambling circuit 25 uses the scrambling parameter to perform logic operations on the input data for scrambling the input data and generating the valid data. In addition, the scrambling circuit 25 may include a plurality of scrambling parameters, so that the values of the non-fixed-constant invalid data are slightly or completely different from the values of the valid data. According to the above description, the buffer 22 buffers the input data, which may be provided to the scrambling circuit 25 via the select circuit 24.

According to an embodiment of the present invention, the above logic operations may be exclusive OR (XOR) operations or other operations. Nonetheless, the operations of the scrambling circuit 25 are not limited to XOR operations for scrambling the input data and generating the valid data. According to another embodiment of the present invention, the scrambling circuit 25 may be a random-number generating circuit. In addition, the scrambling circuit 25 uses the above method to scramble the reference data and generate the invalid data. According to an embodiment of the present invention, the scrambling circuit 25 may have a plurality of scrambling parameters, which are different from each other, to scramble the reference data for generating the non-fixed constant invalid data. The scrambling circuit 25 is further coupled to the control circuit 23 and transmits the valid data and the invalid data to the control circuit 23.

Please refer again to FIG. 1. The flash memory interface 26 is coupled between the control circuit 23 and the flash memory 10. The control circuit 23 receives the valid and invalid data generated by the scrambling circuit 25 and transmits the valid and invalid data to the flash memory interface 26 for writing the valid data to the valid storage zones and the invalid data to the invalid storage zones. When the controller 20 stores the input data to the flash memory 10, the control circuit 23 will write data to the storage zones starting from an address, which may be preset in the controller 20. The control circuit 23 writes the valid data to the valid storage zones. If the storage zones nearby the valid storage zones are invalid storage zones (damaged storage zones or unused storage zones), the control circuit 23 will write the non-fixed-constant invalid data to the invalid storage zones. Thereby, the coupling interference of the invalid storage zones in the nearby valid storage zones may be reduced. Accordingly, the reliability and usable storage space of the flash memory 10 may be increased.

According to an embodiment of the present invention, the flash memory 10 may be pretested for obtaining the conditions of the storage zones of the flash memory 10 and knowing which storage zones are damaged storage zones. The controller 20 may record the address information of the damaged storage zones and the unused storage zones in advance. Then the control circuit 23 may know the address information of the invalid storage zones in advance, which means that whether a valid storage zone is adjacent to an invalid storage zone may be known in advance. The control circuit 23 may control the select circuit 24 according to the address information of the invalid storage zones to select the reference data and output the reference data to the scrambling circuit 25 for generating the invalid data. Thereby, the invalid data are provided to the control circuit 23 for writing the non-fixed-constant invalid data to the invalid storage zones. Likewise, the controller 20 may record the address information of the valid storage zones. Then the control circuit 23 may control the select circuit 24 according to the address information of the valid storage zones to select the input data and output the input data to the scrambling circuit 25 for generating the valid data. Thereby, the valid data are provided to the control circuit 23 for writing the valid data to the valid storage zones.

According to the present embodiment, the controller 20 may further comprise a storage unit 27 for storing the address information of the invalid storage zones, the address information of the valid storage zones, and the reference data. The storage unit 27 is coupled to the select circuit 24 for providing the reference data to the select circuit 24. In addition, the storage unit 27 is coupled to the control circuit 23 for providing the address information of the invalid storage zones or the address information of the valid storage zones to the control circuit 23.

Please refer again to FIG. 1. The controller 20 may further comprise a data filtering unit 28 and a descrambling circuit 29. The data filtering unit 28 is coupled to the control circuit 23 and the descrambling circuit 29. The descrambling circuit 29 is further coupled to the buffer 22. When the control circuit 23 receives the read command transmitted by the host 5, the control circuit 23 will read a data series from the flash memory 10 via the flash memory interface 26. Because the flash memory 10 includes the valid and invalid storage zones, the data series includes the valid data and the invalid data, where the valid data are the data to be stored by the user and the invalid data are not. The control circuit 23 transmits the data series to the data filtering unit 28. The data filtering unit 28 receives the data series and filters the invalid data from the data series for transmitting the valid data to the descrambling circuit 29.

According to an embodiment of the present invention, the data filtering unit 28 filters out the invalid data from the data series according to the address information of the invalid storage zones and keeps the valid data. The data filtering unit 28 may be further coupled to the storage unit 27 for obtaining the address information of the invalid storage zones. Besides, the data filtering unit 28 may keep the valid data according to the address information of the valid storage zones. The data filtering unit 28 may thereby obtain the address information of the valid storage zones from the storage unit 27. The descrambling circuit 29 receives the valid data output by the data filtering unit 28 and descrambles the valid data to generate an output data. According to an embodiment of the present invention, the descrambling circuit 29 includes descrambling parameter, which is identical to the scrambling parameter of the scrambling circuit 25 for performing operations on the valid data and descrambling the valid data to generate the output data. Thereby, the output data may be identical to the input data. The descrambling circuit 29 transmits the output data to the buffer 22. The buffer 22 buffers the output data and provides the output data to the host interface 21 for further transmitting the output data to the host 5.

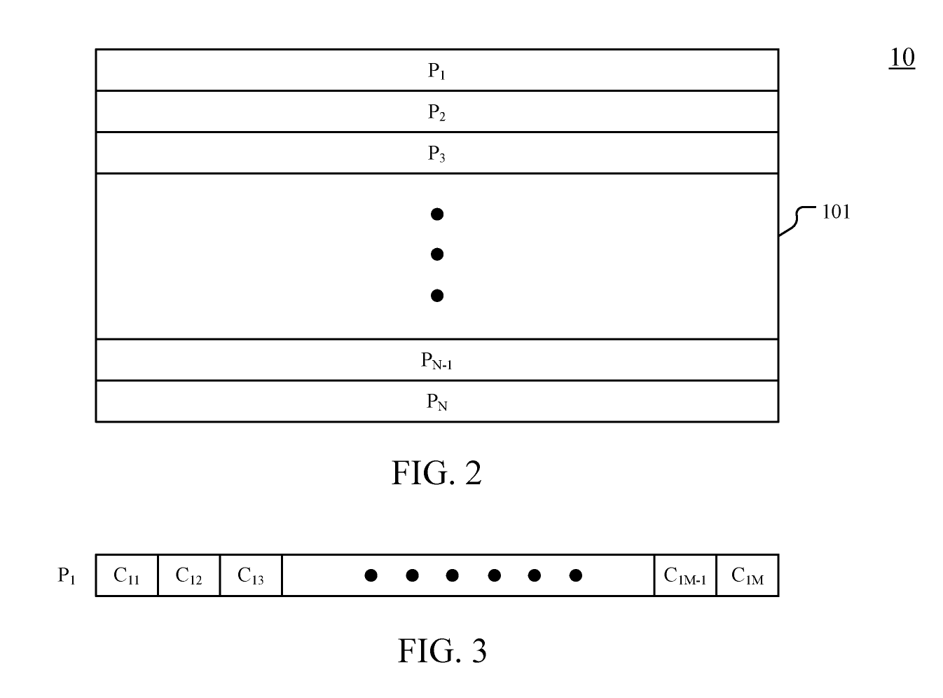

Please refer to FIG. 2, which shows a schematic diagram of the flash memory according to an embodiment of the present invention. As shown in the figure, the flash memory 10 includes at least one storage block 101, which includes a plurality of storage pages P₁-P_{N} with each storage page P₁-P_{N} having a plurality of storage columns, respectively. As shown in FIG. 3, the first storage page P₁ has a plurality of storage columns According to an embodiment of the present invention, the minimum unit of the control circuit 23 writing to the flash memory 10 is, but not limited to, a storage column. In addition, the storage space of a storage column is one or more byte. When the control circuit 23 writes data to the flash memory 10, basically, the control circuit 23 starts from an address sequentially. For example, the control circuit 23 writes data to the flash memory 10 sequentially from the first storage column C₁₁ of the first storage page P₁. According to an embodiment of the present invention, each storage column is a storage zone. If the condition of a storage column is damaged or unused, it means that this storage column is an invalid storage zone. If the condition of a storage column is undamaged and usable, it means that this storage column is a valid storage zone.

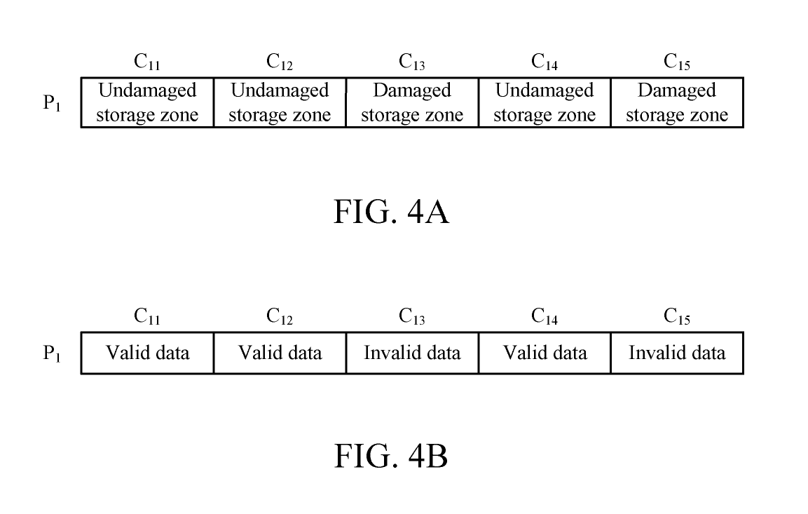

In the following, the rules for the controller 20 to write data to the flash memory 10 will be described. Please refer to FIG. 4A, which shows a schematic diagram of a storage page of the flash memory 10 without written data according to an embodiment of the present invention. As shown in the figure, the first storage page P₁ has five storage columns C₁₁-C₁₅. The third storage column C₁₃ and the fifth storage column Cᵢₛ are damaged and become damaged storage zones (invalid storage zones). The rest storage columns C₁₁, C₁₂, C₁₄ are undamaged and become undamaged storage zones (valid storage zones). When the controller 20 writes the valid data to the first storage page P₁ starting from the first storage column C₁₁ of the first storage page P₁, because the first storage column C₁₁ is not an invalid storage zone, the control circuit 23 controls the select circuit 24 to select the input data transmitted by the host 5. The select circuit 24 outputs the input data to the scrambling circuit 25 for generating the valid data. As shown in FIG. 4B, the control circuit 23 writes the valid data to the first storage column C₁₁. Next, because the second storage column C₁₂ is also a valid storage zone, as shown in FIG. 4B, the control circuit 23 writes the next valid data to the second storage column C₁₂. Next, because the third storage column C₁₃ is a damaged storage zone (invalid storage zone), the control circuit 23 controls the select circuit 24 to select the reference data and output the reference data to the scrambling circuit 25 for generating the non-fixed-constant invalid data. As shown in FIG. 4B, the control circuit 23 writes the invalid data to the third storage column C₁₃. Next, because the fourth storage column C₁₄ is a valid storage zone, the control circuit 23 controls the select circuit 24 to output the input data transmitted by the host 5 to the scrambling circuit 25 for generating the valid data. As shown in FIG. 4B, the control circuit 23 writes the valid data to the fourth storage column C₁₄. Next, because the fifth storage column C₁₅ is a damaged storage zone (invalid storage zone), the control circuit 23 controls the select circuit 24 to select the reference data and output the reference data to the scrambling circuit 25 for generating the invalid data. As shown in FIG. 4B, the control circuit 23 writes the invalid data to the fifth storage column C₁₅.

According to the above description, the control circuit 23 controls the select circuit 24 to select the input data or the reference data according to the condition of the storage zones. It means that the select circuit 24 outputs the input data or the reference data to the scrambling circuit 25 according to the condition of the storage zones for generating valid or invalid data. Thereby, the control circuit 23 may store the valid data to the valid storage zones and the invalid data to the invalid storage zones nearby the valid storage zones according to the condition of the storage zones. Because the invalid data generated by the scrambling circuit 25 are not fixed constants, the invalid data written to the third storage column C₁₃ are different from the invalid data written to the fifth storage column C₁₅. Thereby, the coupling interference of the charging process of the charging circuits for the third and fifth storage columns C₁₃, C₁₅ in the nearby first, second, and fourth storage columns C₁₁, C₁₂, C₁₄ may be reduced. Accordingly, the storage reliability of the first, second, and fourth storage columns C₁₁, C₁₂, C₁₄ may be improved.

For example, the corresponding voltage levels for writing hexadecimal FF and 00 to the flash memory 10 are the minimum and maximum voltage levels, respectively. Assume that a valid storage zone, for example, the first storage column C₁₁, contains the valid data AA at first. According to the prior art, during the charging process of writing the fixed-value invalid data to a plurality of invalid storage zones, such the third and fifth storage columns C₁₃, C₁₅ for multiple times, if the invalid data are FF, then the corresponding voltage for writing the fixed-value invalid data FF will continue to pull down the voltages of nearby valid storage zones; if the invalid data are 00, then the corresponding voltage for writing the fixed-value invalid data 00 will continue to pull up the voltages of nearby valid storage zones. Because the controller 20 according to the present invention writes invalid data of different values to every invalid storage zone, the coupling interference of the charging while writing invalid data to invalid storage zones in the storage elements of nearby valid storage zones may be reduced. Likewise, while writing different valid data to every valid storage zone, the coupling interference between valid storage zones may be reduced as well. Accordingly, the coupling interference among the storage pages P₁-P_{N} may be improved.

Furthermore, because the interference of the third and fifth storage columns C₁₃, Cᵢₛ in the fourth storage column C₁₄ is reduced, the data error rate of the fourth storage column C₁₄ will be lowered accordingly. Then the fourth storage column C₁₄ may be used for storing valid data. Consequently, by controlling the flash memory 10 using the controller 20 and control method according to the present invention, the undamaged storage zone (C₁₄) located between two damaged storage zones (C₁₃, C₁₅) may be used as a valid storage zone for storing valid data, which is different from the prior art. According to the prior art, the undamaged storage zone between two damaged ones is regarded as an invalid storage zone and valid data will not be stored therein. Accordingly, compared to the prior art, the controller 20 and the control method according to the present invention may increase the usable storage space of the flash memory 10.

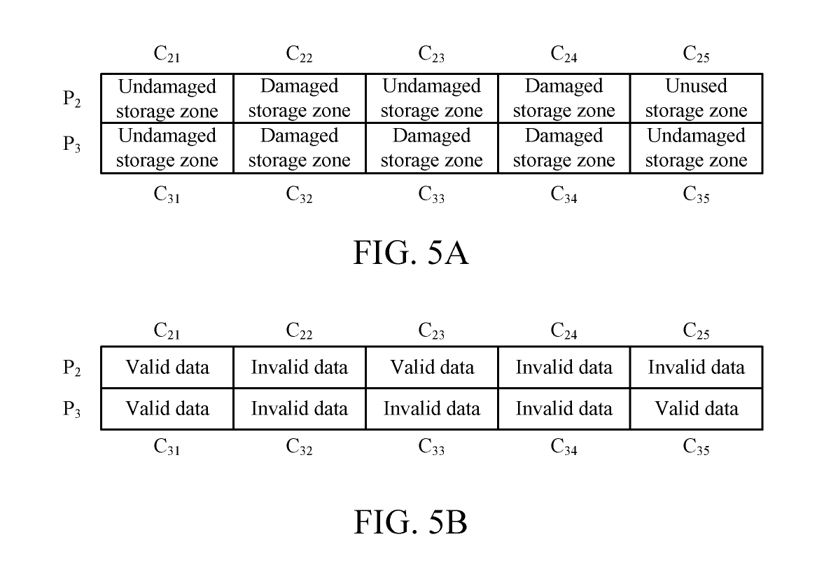

Please refer to FIG. 5A, which shows a schematic diagram of a storage page of the flash memory 10 without written data according to another embodiment of the present invention. As shown in the figure, the second storage page P₂ has five storage columns C₂₁-C₂₅, and the third storage page P₃ also has five storage columns C₃₁-C₃₅, where the storage columns C₂₂, C₂₄, C₃₂, C₃₃, C₃₄ are damaged and become damaged storage zones (invalid storage zones), and the storage columns C₂₁, C₂₃, C₃₁, C₃₅ are not damaged and become undamaged storage zones (valid storage zones). According to the present embodiment, the third storage page P₃ has only two undamaged storage columns C₃₁, C₃₅, meaning that the third storage page P₃ has only two valid storage zones for storing valid data. For facilitating management on the storage space of the flash memory 10, the administrator will set the valid storage capacity of two adjacent storage pages identical. According to the present embodiment, the fifth storage column C₂₅ of the second storage page P₂ is preset to be an unused storage zone (invalid storage zone) and store no valid data, so that the adjacent second and third storage pages P₂, P₃ has identical numbers of valid storage zones (two valid storage zones). In other words, the valid storage capacity of the second storage page P₂ is identical to the valid storage capacity of the third storage page P₃. As shown in FIG. 5B, because the storage columns C₂₂, C₂₄, C₂₅, C₃₂, C₃₃, C₃₄ are invalid storage zones and store no valid data, the control circuit 23 writes the invalid data to the storage columns C₂₂, C₂₄, C₂₅, C₃₂, C₃₃, C₃₄ and the valid data to the storage columns C₂₁, C₂₃, C₃₁, C₃₅.

Please refer to FIG. 1, according to an embodiment of the present invention, the controller 20 may store at least one invalid data, which are not a fixed constant, in advance for providing to the control circuit 23. For example, the invalid data may be stored in the storage unit 27. Thereby, the controller 20 does not need the select circuit 24 to select the reference data. The control circuit 23 may write the invalid data provided by the storage unit 27 to the invalid storage zones. The buffer 22 may provide the input data to the scrambling circuit 25 directly.

To sum up, the flash memory controller and the method for controlling a flash memory according to the present invention provide at least one invalid data. The invalid data are not a fixed constant. While performing the operation of writing at least one input data transmitted by the host to the flash memory, scramble the input data for generating at least one valid data. The control circuit writes the valid data to at least one valid storage zone of the flash memory, and the invalid data to at least one invalid storage zone of the flash memory. Thereby, the interference of the invalid storage zones in the valid storage zones may be reduced, and the reliability and usable storage space of the flash memory may be increased.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

What is claimed is:

1. A flash memory controller, controlling a flash memory, and comprising:
a scrambling circuit, receiving and scrambling at least one input data for generating at least one valid data; and
a control circuit, coupled to said scrambling circuit, receiving at least one invalid data and said at least one valid data generated by said scrambling circuit, said at least one invalid data being not a fixed constant, writing said at least one valid data to at least one valid storage zone of said flash memory, and writing said at least one invalid data to at least one invalid storage zone of said flash memory.

2. The flash memory controller of claim 1, further comprising:
a data filtering unit, coupled to said control circuit for receiving at least one data series read by said control circuit from said flash memory, said at least one data series including said at least one valid data and said at least one invalid data, and said data filtering unit filtering out said at least one invalid data from said at least one data series according to the address information of said at least one invalid storage zone and keeping said at least one valid data; and
a descrambling circuit, coupled to said data filtering unit for receiving said at least one valid data output by said data filtering unit, and descrambling said at least one valid data for generating at least one output data.

3. The flash memory controller of claim 2, further comprising a storage unit, coupled to said data filtering unit and said control circuit, and storing the address information of said at least one invalid storage zone.

4. The flash memory controller of claim 1, further comprising a select circuit, receiving said at least one input data and at least one reference data, coupled to said control circuit and said scrambling circuit, respectively, said control circuit controlling said select circuit to select said at least one input data or said at least one reference data according to the address information of said at least one valid storage zone or the address information of said at least one invalid storage zone for outputting said at least one input data or said at least one reference data, and said scrambling circuit receiving said at least one reference data output by said select circuit and scrambling said at least one reference data for generating said at least one invalid data.

5. The flash memory controller of claim 4, further comprising a storage unit, coupled to said select circuit and said control circuit, storing the address information of said at least one invalid storage zone, the address information of said at least one valid storage zone, and said at least one reference data.

6. The flash memory controller of claim 1, further comprising a storage unit, coupled to said control circuit, and storing said at least one invalid data.

7. The flash memory controller of claim 1, wherein said at least one invalid storage zone includes at least one damaged storage zone or/and at least one unused storage zone of said flash memory.

8. The flash memory controller of claim 1, further comprising:
a host interface, coupled to a host, said host transmitting said at least one input data to said host interface;
a buffer, coupled to said host interface, said host interface transmitting said at least one input data to said buffer, and said buffer providing said at least one input data to said scrambling circuit; and
a flash memory interface, coupled between said control circuit and said flash memory.

9. A method for controlling a flash memory, comprising:
receiving at least one input data;
scrambling said at least one input data for generating at least one valid data;
providing at least one invalid data, and said at least one invalid data being not a fixed constant;
writing said at least one valid data to at least one valid storage zone of said flash memory; and
writing said at least one invalid data to at least one invalid storage zone of said flash memory.

10. The method for controlling a flash memory of claim 9, further comprising:
providing at least one reference data; and
scrambling said at least one reference data for generating said at least one invalid data.

11. The method for controlling a flash memory of claim 9, further comprising:
reading at least one data series from said flash memory, and said at least one data series including said at least one valid data and said at least one invalid data;
filtering out said at least one invalid data from said at least one data series according to the address information of said at least one invalid storage zone, and keeping said at least one valid data; and
descrambling said at least one valid data, and generating at least one output data.

12. The method for controlling a flash memory of claim 9, wherein said at least one invalid storage zone includes at least one damaged storage zone or/and at least one unused storage zone of said flash memory.
